(19) United States
(12) Patent Application Publication
(10) Pub. No.: US 2026/0220540 A1
(43) Pub. Date: Jul. 30, 2026

(54) ESTIMATING LOCAL FEATURE IMPORTANCE

(71) Applicant: Oracle International Corporation, Redwood Shores, CA (US)

(72) Inventors: Ali Seyfi, Vancouver (CA); Yasha Pushak, Vancouver (CA); Hesam Fathi Moghadam, Sunnyvale, CA (US); Rhicheek Patra, Zurich (CH); Sungpack Hong, Palo Alto, CA (US)

(21) Appl. No.: 19/196,100

(22) Filed: May 1, 2025

Related U.S. Application Data
(60) Provisional application No. 63/751,729, filed on Jan. 30, 2025.

(51) Int. Cl. G06N 20/00

(52) U.S. Cl. CPC G06N 20/00

(57) ABSTRACT

Here is generation of a local explanation of a machine learning (ML) inference, and this generation is accelerated by accurate estimation of local feature value importances from a multioutput regression by an attribution metamodel. Into a feature vector, a computer stores values for respective features and stores an inference, from the feature values, by an ML model. A multioutput regression by an attribution metamodel includes inferentially generating, from the feature vector, local value importances respectively for the feature values. Based on the local value importances, a local explanation of the inference is generated and displayed. For accelerated training with early stopping, an adaptively selected training corpus involves incrementally adding additional datapoints to the training corpus until the attribution metamodel accurately learns.

### BENEFIT CLAIM

This application claims benefit under 35 U.S.C. § 119(e) of provisional application 63/751,729, filed January 30, 2025, by Ali Seyfi et al, the entire contents of which is hereby incorporated by reference.

### FIELD OF THE INVENTION

Generation of a local explanation of a machine learning inference is accelerated by accurate estimation of local feature value importances from a multioutput regression by an attribution metamodel.

### BACKGROUND

In many machine learning and predictive modeling tasks, understanding how individual features contribute to a model's predictions can be crucial for interpretability, trust, and transparency. One common approach for interpreting model predictions is the use of explainability techniques that calculate local feature attributions, which indicate how each feature influences a particular prediction. Methods such as SHAP (Shapley Additive Explanations) and other model-agnostic approaches are widely used in industry for this purpose. These methods, although effective, often come with significant computational costs, especially when applied to complex models or large datasets. The time required for calculating local feature importance using these techniques can be prohibitive, leading to delays in decision-making, especially in real-time applications where speed is essential.

The primary challenge lies in the fact that these explainability methods typically require repeated evaluations of the model for each instance of interest, which becomes computationally expensive. For large datasets with high-dimensional feature spaces, the need to recompute explanations for each prediction can result in long processing times, making it difficult to scale these methods to real-world applications. In industries such as finance, healthcare, and autonomous systems, where decisions often need to be made quickly and transparently, this time inefficiency can create significant barriers to adoption. Additionally, for models with numerous features, the complexity of explaining the impact of each feature individually compounds the problem. As a result, the industry has been searching for more efficient, scalable methods that retain the accuracy of traditional explainability techniques but reduce the associated computational costs.

### BRIEF DESCRIPTION OF THE DRAWINGS

In the drawings:

FIG. 1 is a block diagram that depicts an example computer that generates, as accelerated by accurate estimation of local value importances of features, a local explanation of a machine learning (ML) inference;

FIG. 2 is a screenshot of an example bar chart as a presentation of an example local explanation;

FIG. 3 is a flow diagram that depicts a computer process that on-demand generates, as accelerated by multioutput regression by an attribution metamodel that provides accurate estimation of local value importances, a local explanation of an ML inference 140;

FIG. 4 is a flow diagram that depicts a computer process that self-supervised trains and self-supervised validates an attribution metamodel;

FIG. 5 is a block diagram that illustrates a computer system upon which an embodiment of the invention may be implemented;

FIG. 6 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

Here is generation of a local explanation of a machine learning (ML) inference, and this generation is accelerated by accurate estimation of local feature value importances from a multioutput regression by an attribution metamodel. This approach estimates local feature value importances by predicting them based on a subset of feature values, offering a faster alternative to traditional explainability methods that can be computationally expensive and time-consuming, especially for a complex ML model or a complex feature set. This approach avoids exhaustive computations such as empirically measuring feature importances. This approach is particularly beneficial for applications requiring real-time or large-scale interpretability, where speed is crucial. After deployment, repetitive evaluations of an ML model are entirely avoided, making the process significantly faster while still providing accurate and meaningful explanations of an ML model's behavior.

By focusing on the relationship between input features, the target variable, and their respective attributions, this method eliminates the need for exhaustive calculations traditionally required for local explainability. The result is a faster and more efficient way to estimate feature importance while maintaining accuracy and interpretability, making it ideal for large-scale datasets and real-time systems. This approach is broadly applicable across different industries and predictive modeling scenarios, offering a general and flexible solution for ML model interpretability. Scalability and efficiency make this approach a valuable tool for improving transparency, enabling quicker decision-making, and enhancing trust in ML models.

This approach introduces a method for efficiently estimating local feature importances by leveraging a data-driven approach. The method begins by training a novel metamodel using a dataset where feature values and target variables serve as inputs, and precomputed feature attributions, derived using traditional explainability techniques, serve as correct labels to compare with outputs. Once trained, this attribution metamodel can generalize the relationship between feature values and their attributions, enabling it to predict feature attributions for new inferences from new datapoints without requiring repeated evaluations of the original ML model.

This approach has at least the following innovative aspects. After deployment, direct estimation of feature value importances can occur without relying on iterative or computationally expensive methods, making this approach highly suitable for real-time scenarios where delays of even a few seconds are unacceptable. Unlike alternative approaches where explanations for all potential samples are pre-computed and stored for faster real-time retrieval, which is an approach that would incur a significant offline storage and computational cost, the approach herein computes feature importances dynamically. This dynamism eliminates the need for massive storage while still ensuring instantaneous responses during live requests.

This is a training-based approach that utilizes an attribute metamodel to generalize the relationship between feature values, a target variable, and their corresponding attributions, which introduces a novel predictive framework for interpretability. There is a fallback mechanism for unexpected data scenarios. If data to be explained lies significantly outside the training data distribution of the attribution metamodel, the system can identify such cases using anomaly detection or rule-based approaches. Only if needed in that way, this approach then falls back to a state of the art explainer for accurate feature importance computation. Training data can be reused to periodically, quickly retrain the attribution metamodel, ensuring continuous adaptation and robustness.

This approach is able to stop training early for acceleration by dynamically monitoring accuracy convergence. This ensures that the metamodel halts training once sufficient accuracy is achieved, significantly decreasing computational overhead while maintaining accuracy. This capability is particularly advantageous in scenarios requiring rapid ML model development or limited computational resources. With state of the art accuracy, this approach generates a local explanation faster. Conversely in state of the art time, this approach generates a more accurate local explanation.

This approach has at least the following advantages. This approach introduces a method for estimating local feature importances directly from feature values and a target variable, avoiding the need for computationally expensive explainability methods. The approach is efficient and scalable, enabling it to handle a large dataset and a complex ML model without significant computational overhead.

This approach provides real-time interpretability. Feature value importance estimates are generated in real-time, making it suitable for time-sensitive applications. This approach has a model-agnostic design that ensures broad applicability across application domains, providing a universal solution for feature importance estimation. The method can be applied to any type of ML model, including an opaque (i.e. black-box) ML model and regardless of the ML model's architecture or complexity. By shifting the computational burden to the training phase, this method significantly reduces the runtime required after deployment for generating feature value importance estimates. By providing fast and interpretable insights, this approach supports better and quicker decision-making processes.

### 1.0 EXAMPLE COMPUTER

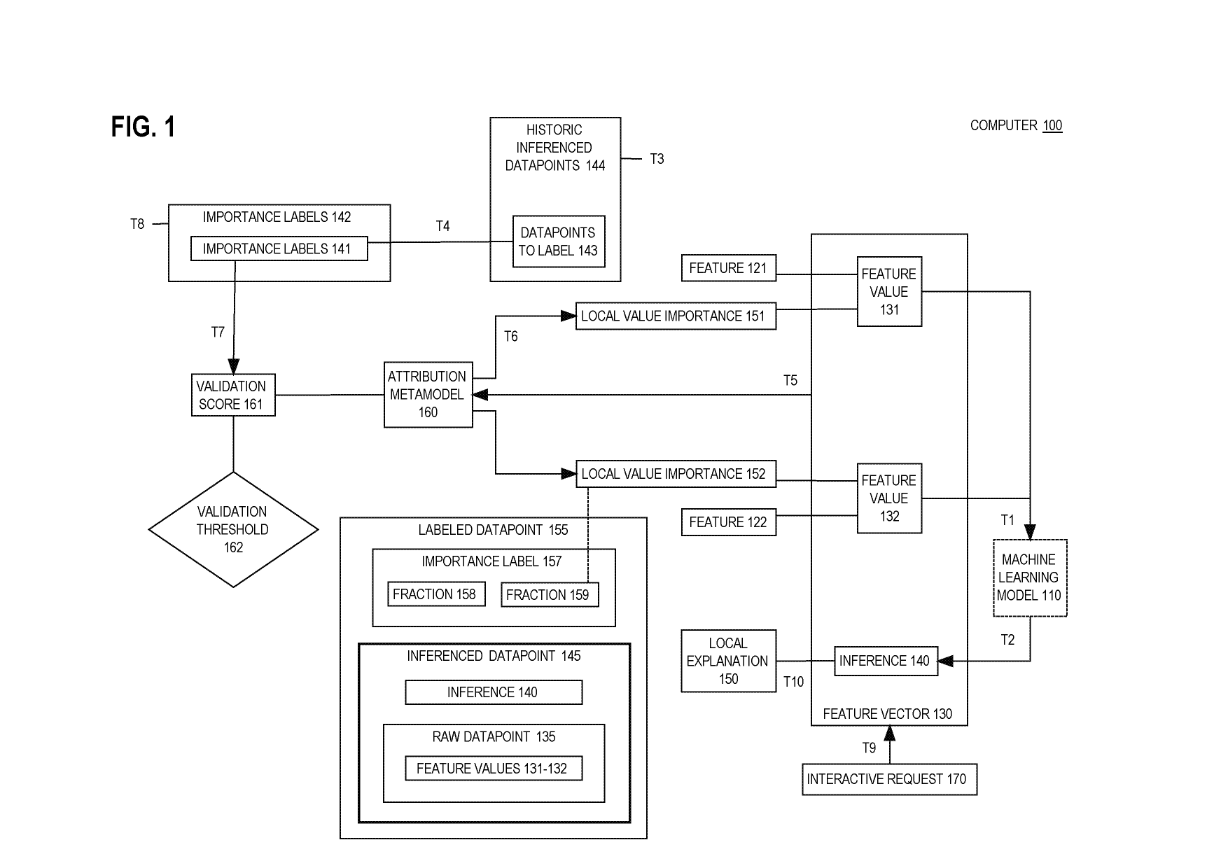

FIG. 1 is a block diagram that depicts an example computer 100 that generates local explanation 150 of machine learning (ML) inference 140, and this generation is accelerated by accurate estimation of local value importances 151-152 of respective features 121-122. This estimation entails multioutput regression by attribution metamodel 160. Computer 100 may be one or more computers such as a rack server such as a blade, a personal computer, a mainframe, or a virtual computer. All components shown in FIG. 1 may be respectively stored and operated in volatile or nonvolatile storage of computer 100.

In an interactive scenario discussed later herein, ML model 110 already generated inference 140, and interactive request 170 triggers on-demand (i.e. dynamic) generation of local explanation 150 that reveals which of feature values 131-132 of respective features 121-122 caused ML model 110 to generate inference 140. ML model 110 may be referred to herein as the target model.

In various embodiments, ML model 110 functions as a classifier, a regression, or an anomaly detector. For example, inferences 140-142 may all be classifications, numbers such as scores or probabilities, or binary detections. In various embodiments, ML model 110 already was supervised or unsupervised trained. ML model 110 may have any model architecture presented later herein, such as an artificial neural network or a random forest.

ML model 110 may be opaque (i.e. black box). For example, users of computer 100 might not know what is the architecture of ML model 110 nor whether its training was supervised or not. For example, the training corpus of ML model 110 might be unavailable or no longer exist.

### 1.1 RETAINED HISTORY OF UNEXPLAINED INFERENCES

As follows, computer 100 operates at times T1-T10 that are sequential such that time T1 precedes time T2, and time T10 is last. ML model 110 is shown with a dashed outline to indicate that ML model 110 and times T1-T2 are optional in computer 100 because in most embodiments times T1-T2 already happened on a different computer. In an embodiment, computer 100 has no access to ML model 110, which techniques herein do not require. As discussed later herein, computer 100 uses historic inferenced datapoints 144 instead of using ML model 110.

For demonstration, times T1-T2 may occur on computer 100 as follows. ML model 110 already was trained before time T1. The duty cycle of ML model 110 consists of times T1- T2. At time T1, ML model 110 accepts an input that contains feature values 131-132 respectively for features 121-122. Each of features 121-122 may have a respective datatype such as a scalar such as a number or a string.

Acceptance of that input by ML model 110 causes ML model 110 to generate inference 140 from feature values 131-132 at time T2. Feature values 131-132 are redundantly shown in data structures 130 and 135. The linear (i.e. sequential) lifecycle of a datapoint progresses as follows. At time T1, raw datapoint 135 consists solely of feature values 131-132, and inference 140 has not yet been generated. At time T2, raw datapoint 135 is associated with inference 140 to provide inferenced datapoint 145. Techniques herein do not require inference 140 to be correct or accurate.

As discussed later herein, the linear lifecycle of data enrichment may initially entail raw datapoint 135, later enriched as inferenced datapoint 145, and later further enriched as labeled datapoint 155. Data enrichment herein is not lossy. For example, inferenced datapoint 145 contains or references raw datapoint 135, and labeled datapoint 155 contains or references datapoints 135 and 145. Times T1-T2 may be repeated for many raw datapoints to provide, at time T3, an archival corpus of many inferenced datapoints, shown as historic inferenced datapoints 144.

Inference 140 might be structurally simple, such as a Boolean. However due to opacity or complexity of ML model 110, the reason that ML model 110 generated inference 140 may be more or less mysterious without inferential analysis by attribution metamodel 160 that is a ML model whose function is multioutput regression. Multioutput regression generates multiple output numbers in a single inference. That is, computer 100 may have two ML models 110 and 160 that each has its own model architecture and model function. For example, ML models 110 and 160 may respectively be an artificial neural network and a random forest or vice versa. Regardless of what is the function of ML model 110, multioutput regression is the function of attribution metamodel 160.

Herein, a raw data point has no inference, no ground truth label, no attribution, and no importance label. Herein, a ground truth label (not shown) is a known correct value that ML model 110 would infer only if ML model 110 were accurate (i.e. already trained). Herein, an importance label is a local (i.e. for a particular inference from a particular data point) attribution that quantifies how respectively important (i.e. influential on ML model 110) are multiple (e.g. all or top k few) features 121-122. Herein, importance unlabeled describes a datapoint that has no importance label, regardless of whether or not the datapoint has a label for comparison to an inference by ML model 110. In an embodiment, an importance label contains a separate respective importance measurement for each of features 121-122, and each measurement is a fraction of total importance to an inference that is attributed to the feature. The fraction may be a percentage or a real number from zero to one or, as discussed later herein, a real number from negative one to positive one. The magnitude (i.e. absolute value) of an importance measurement indicates how influential is the feature, where zero indicates irrelevance (i.e. unimportance).

### 1.2 ATTRIBUTION METAMODEL TRAINING

At time T3, all historic inferenced datapoints 144 are importance unlabeled. From historic inferenced datapoints 144 at time T4, datapoints to label 143 are a small randomly selected subset of historic datapoints. Except as discussed later herein, a count of datapoints to label 143 should be small because generating importance labels 141 respectively for datapoints to label 143 is slow (i.e. a rate limiting computational bottleneck) as discussed later herein. For accelerated training of attribution metamodel 160 as discussed later herein, adaptive sampling of inferenced datapoints from historic inferenced datapoints 144 without replacement is used.

Data 141 and 143 together may be a small training corpus for attribution metamodel 160. In an embodiment, cross validation is used for attribution metamodel 160, and datapoints to label 143 are divided into multiple folds (i.e. subsets), with one fold withheld from training and instead used for validation. Training acceleration herein, attribution metamodel 160 may have various adaptive training embodiments as follows. In an embodiment, training attribution metamodel 160 occurs as a sequence of multiple training epochs, where each epoch reuses and adaptively expands the training corpus of the previous epoch.

The first training epoch entails times T4-T6. Herein, each training epoch starts by importance labeling (i.e. generating importance labels) some more datapoints from historic inferenced datapoints 144. Importance labeling in the first epoch occurs at time T4.

Training attribution metamodel 160 entails a duty cycle repeated by attribution metamodel 160, for each datapoint in the training corpus of the current training epoch. The duty cycle of attribution metamodel 160 consists of times T5-T6. At time T5, feature vector 130 is generated, and feature values 131-132 are stored in feature vector 130. Feature values 131-132 may be collectively referred to herein as a target tuple or a raw datapoint. Inference 140 may be referred to as a target inference. In an embodiment, feature vector 130 consists of an inferenced datapoint. For example, feature vector 130 may represent inferenced datapoint 145.

At time T5, attribution metamodel 160 accepts feature vector 130 as a whole input, which causes attribution metamodel 160 to inferentially generate local value importances 151- 152 at time T6. Local value importances 151-152 quantitatively measure how respectively important (i.e. influential) were feature values 131-132 at causing ML model 110 to generate inference 140.

For example, features 121-122 may respectively be velocity and traffic light color, and inference 140 may be an inferred alert such as a Boolean (i.e. alert or no alert). Depending on the scenario, feature values 131-132 may be respectively more and less important or vice versa. For example, feature value 132 being red may be more influential on the operation of ML model 110 than if feature value 132 instead were green. Likewise for feature value 131, a value of 100 may be more influential than a value of 10. Which of feature values 131-132 is more influential for inference 140 might depend on the combination of feature values 131-132. For example, sometimes traffic light color may be more important, and other times velocity is more important, and these relative importances may depend on feature values 131-132. For example, how important is velocity may depend on traffic light color and, conversely, how important is traffic light color may depend on velocity

### 1.3 LOCAL IMPORTANCES OF FEATURE VALUES

At time T6, attribution model 160 generates a single inference that contains multiple local value importances 151-152 for respective features 121-122. Local value importances 151- 152 are accurate estimates that are quickly generated such as on demand and more or less instantaneously. Value importance 151 is local to data components 130-132 and 140 because a different inference or feature value(s) may cause a different local value importance 151 for components 121 and 131. For example, changing feature value 132 of feature 122 might change local value importance 151 of feature value 131 of feature 121. That is, the value of one feature may affect the importance of the value of another feature. Thus, local value importances 151- 152 are not global importances.

Local value importances 151-152 are estimates that are quickly inferentially generated, and these estimates can be compared to importances that are more accurate but slowly generated by the state of the art that is extremely computationally intensive. Importance labels 141 are used herein for self-supervised training of attribution metamodel 160, which increases the accuracy of attribution metamodel 160. Herein, self-supervision entails just-in-time (i.e. on demand) automatic generation of correct importance labels during training. For unconventional acceleration, self-supervision herein is adaptively (i.e. incrementally) applied as a sequence of training epochs that each generates additional importance labels as follows.

This training increases accuracy of components 160 and 150-152, which will increase validation score 161 that will be measured at time T6. In an embodiment: a) local value importances 151-152 are ranked; and b) validation score 161 is normalized discounted cumulative gain (NDCG) that measures how similar are two rankings, which are i) local value importances 151-152 and ii) the correct importances in the importance label. NDCG weights similar importances near the top (i.e. most relevant features) of the list higher than similarities near the bottom (i.e. least relevant features).

### 1.4 ADAPTIVE SEQUENCE OF TRAINING EPOCHS

Herein is a sequence of increasingly intensive repeated trainings of attribution metamodel 160, including a first training that spans times T4-T6 and, as follows, a more intensive second training that spans times T7-T8. First and second trainings at respective times T5 and T8 are separated by a failed validation at time T7 that detects that validation score 161 of attribution metamodel 160 is insufficient because validation score 161 does not exceed validation threshold 162. In a cross-validated example, there could be two training folds for use at times including T5-T6 and one validation (i.e. holdout) fold used at time T7. In that case, each of components 141 and 143 is divided into three folds.

A second training epoch, including a second importance labeling and a second self- supervised training, occurs at time T8 because the first epoch failed validation at time T7. The self-supervised training corpus in the first epoch consists of data 141 and 143. In the second epoch, the self-supervised training corpus consists of importance labels 142 and a respective subset (not shown) of historic inferenced datapoints 144. Because each epoch reuses and expands the training corpus of the previous epoch, importance labels 142 includes importance labels 141, and the training datapoints in the current epoch are a combination of datapoints to label 143 and additional randomly selected datapoints (not shown).

In an exponentially adaptive embodiment, each training epoch selects and importance labels more datapoints than the previous epoch selected and importance labeled. In a monotonically adaptive embodiment, each epoch selects and importance labels a same predefined count of datapoints. The sequence of training epochs continues until a stopping condition occurs such as a time limit, an epoch count limit, a minimum validation score is achieved by attribution metamodel 160, or a minimum improvement (e.g. increase) in validation score between two epochs does not occur. When the sequence of epochs ends, attribution metamodel 160 is ready for production use. Adaptive sampling accelerates the sequence of epochs by minimizing training corpus size, and this minimizes how many importance labels are generated, which is acceleration of the rate-limiting training step. In a neural network embodiment of attribution metamodel 160, backpropagation is much faster than importance labeling, which is an example of why importance labeling is the rate-limiting training step.

### 1.5 PRODUCTION USE

Between times T8-T9, attribution metamodel 160 may be deployed into production for use at times T9-T10 that do not use components 142, 144, and 162. As discussed earlier herein, attribution metamodel 160 has a duty cycle that a accepts feature vector 130 as a whole input. During training, the duty cycle is repeated for each training datapoint in the training corpus of a training epoch. In the shown embodiment at time T9 during production use, interactive request 170 triggers a production duty cycle instead of a training duty cycle. Interactive request 170 may, for example, be a hypertext transfer protocol (HTTP) request or a mouse click such as a pushbutton press.

Interactive request 170 may identify an unlearned (e.g. new) datapoint that attribution metamodel 160 did not train with. The unlearned datapoint may or may not be in historic inferenced datapoints 144. In an embodiment, historic inferenced datapoints 144 is retained but accessible only during training and validation. For example at time T9, interactive request 170 may identify either of: a) a new datapoint that is not in historic inferenced datapoints 144 or b) an importance unlabeled datapoint in historic inferenced datapoints 144. For those various reasons and circumstances, in this production use example, either of feature values 131-132 may be unfamiliar (i.e. new) to attribution metamodel 160 or, even if both feature values 131-132 are familiar, the combination of feature values 131-132 together may be unfamiliar.

At time T9, feature vector 130 is generated, and feature values 131-132 are stored in feature vector 130. Feature values 131-132 may be collectively referred to herein as a target tuple or a raw datapoint, and feature vector 130 contains inferenced datapoint 145 that contains both of raw datapoint 135 and inference 140. Inference 140 may be referred to as a target inference.

Several activities occur at time T10. At time T10, attribution metamodel 160 infers local value importances 151-152. From local value importances 151-152 at time T10, computer 100 generates local explanation 150 that explains why ML model 110 inferred inference 140 for inferenced datapoint 145. Local explanation 150 may rank features 121-122 by local value importances 151-152 and, for example, include only a top k few most important features. When displayed to a user, local explanation 150 may be tabular or, if local value importance is an graph axis, plotted.

### 2.0 EXAMPLE COMPUTER DISPLAY

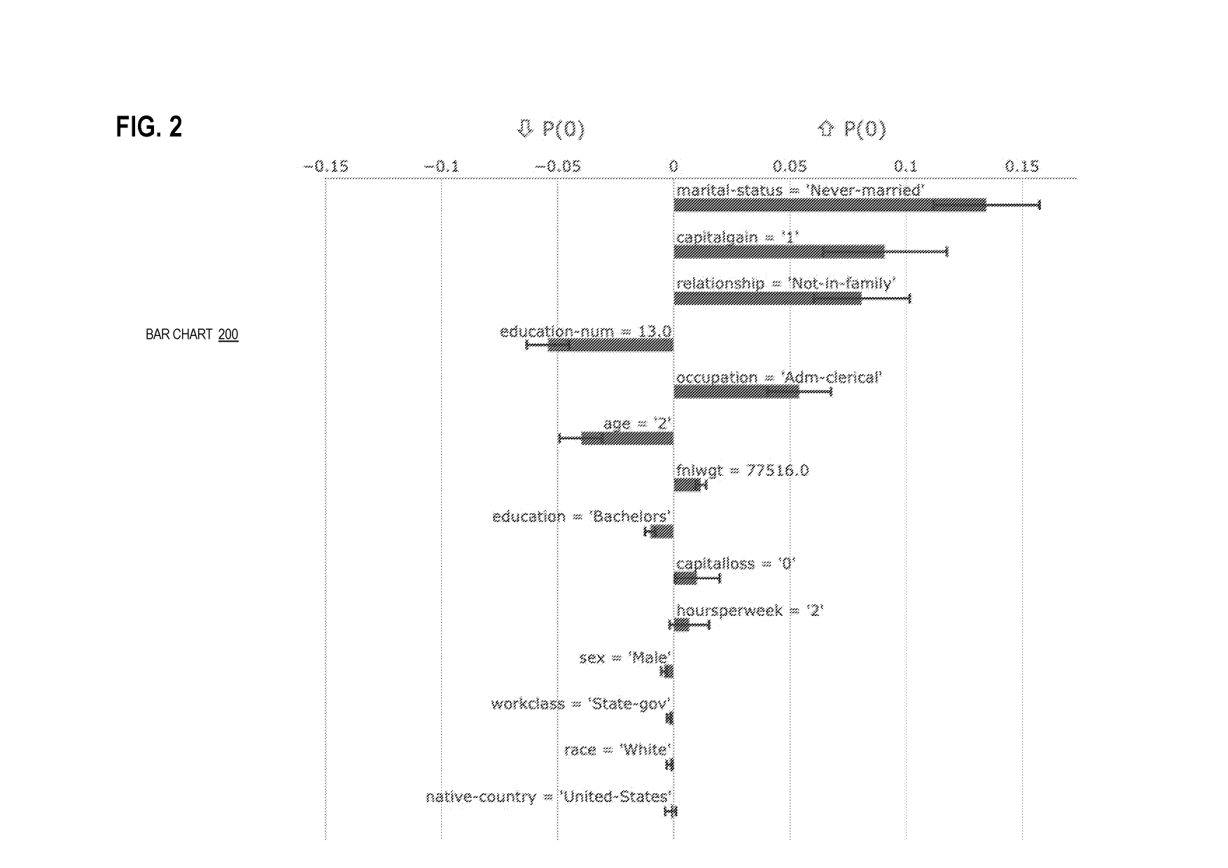

FIG. 2 is a screenshot that depicts an example bar chart 200 that is an example local explanation 150 that computer 100 generates and displays for inference 140. In this example: a) machine learning (ML) model 110 is a classifier; b) inference 140 contains a respective probability of at least one class of multiple classes; and c) inference 140 is a classification, which is the class with the highest inferred probability. In the shown example: a) one of the classes is class 0; and b) shown P(0) is the inferred probability of class 0, which is the highest inferred probability of the multiple classes. That is in this example, inference 140 is a classification that designates class 0.

Bar chart 200 shows a vertical stack of fourteen horizontal bars. The horizontal axis of bar chart 200 indicates local value importance as inferred by attribution metamodel 160, and zero is the origin of the horizontal axis, which means that zero, one, or both of local value importances 151-152 may be negative in this example. Each horizontal bar represents a distinct one of fourteen features, including features 121-122. The length of a horizontal bar indicates the magnitude of the local value importance for a feature. Horizontal bars on the right side of the origin represent features that have positive local value importances, which means that attribution metamodel 160 inferred that the values of those features caused ML model 110 to: a) increase probability P(0) for class 0, and b) classify the datapoint as belonging to class 0. Conversely, horizontal bars on the left side of the origin represent features that have negative local value importances, which means that attribution metamodel 160 inferred that the values of those features caused ML model 110 to decrease probability P(0), but not enough to change the classification to a class other than class 0.

Each horizontal bar is visually labeled to indicate which feature and which feature value. That is, bar chart 200 shows: a) each of all features 121-122 as a distinct horizontal bar, b) respective feature values 131-132 as labels on respective horizontal bars, and c) the length of each horizontal bar is directly proportional to a respective one of inferred local value importances 151-152. By inferring value importances, attribution metamodel 160 effectively infers lengths for generating horizontal bars, and the shown horizontal bars are sorted by length (i.e. sorted by magnitude of value importance as an absolute value). Visually, bar chart 200 is shown as a vertical stack of features and values, and that stack is sorted by value importance magnitude (i.e. bar length). The magnitude of the sum of lengths of horizontal bars to the right of the origin exceeds the magnitude of the sum of lengths of horizontal bars to the left of the origin.

### 3.0 EXAMPLE ACCELERATED LOCAL EXPLANATION PROCESS

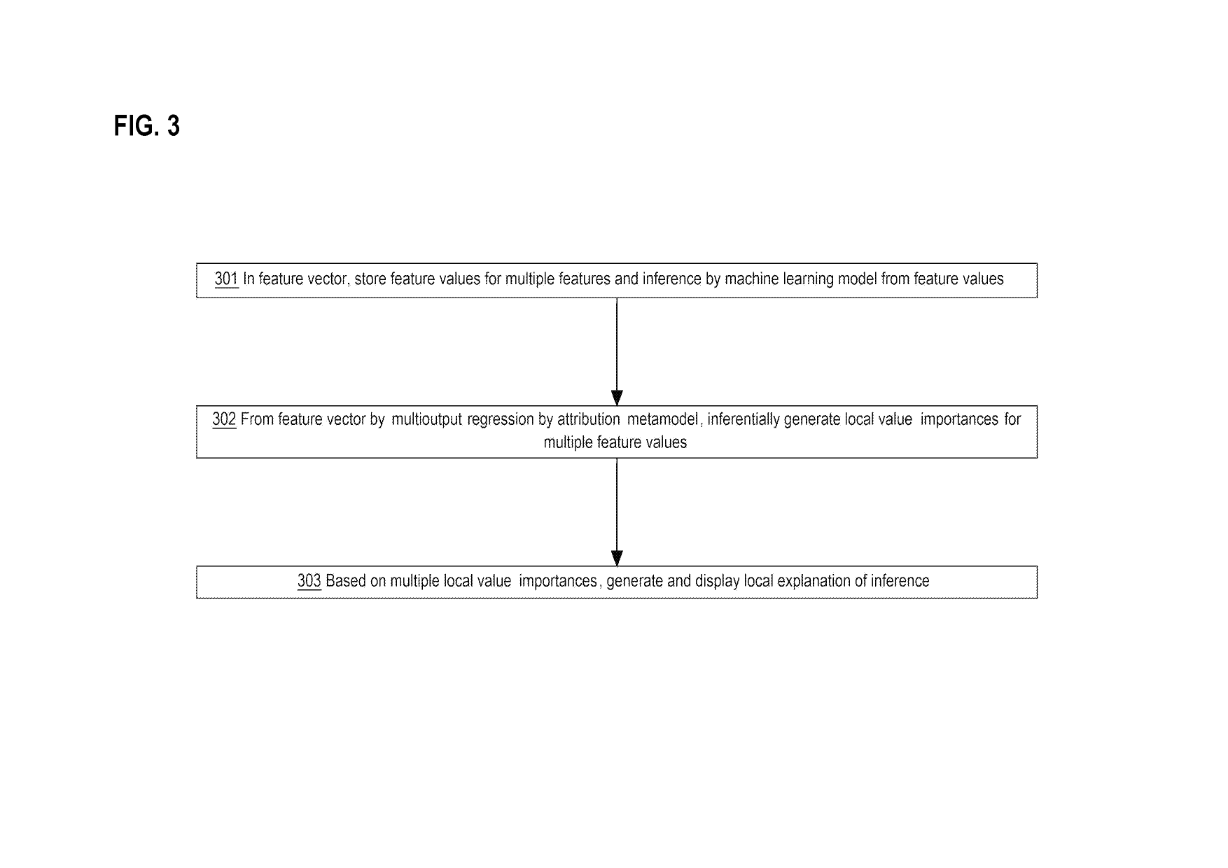

FIG. 3 is a flow diagram that depicts an example process that computer 100 performs on demand to generate local explanation 150 of ML inference 140, which is accelerated by multioutput regression by attribution metamodel 160 that provides accurate estimation of local value importances 151-152 of respective features 121-122.

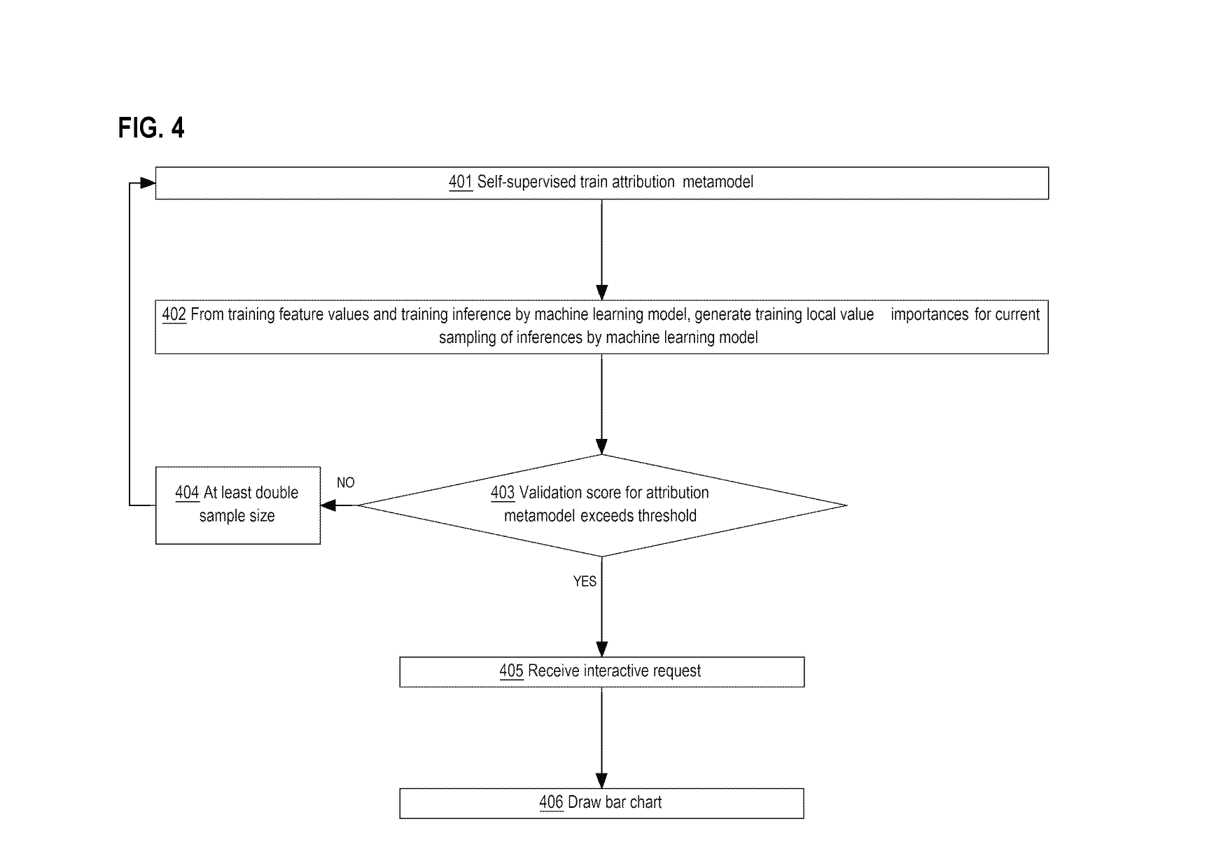

Times T1-T8 in FIG. 1, including training and validating attribution metamodel 160, occur before the process in FIG. 3. Training and validating attribution metamodel 160 are presented with later FIG. 4. Into feature vector 130 at time T9, step 301 stores: a) a raw datapoint consisting of multiple feature values 131-132 respectively for multiple features 121- 122 and b) inference 140 by ML model 110 from feature values 131-132. For example, step 301 may load the datapoint or inference 140 from a history log file, a history table in a database, or directly from within interactive request 170. Step 301 generates and populates feature vector 130, and feature vector 130 consists of an inferenced datapoint that consists of a raw datapoint and target inference 140. Herein, the raw datapoint and target inference 140 are collectively referred to as an inferenced datapoint, which is the sole content of feature vector 130.

From feature vector 130 in step 302, attribution metamodel 160 performs multioutput regression that inferentially generates local value importances 151-152 for feature values 131- 132. Based on local value importances 151-152, step 303 generates and displays local explanation 150 for inference 140. In an embodiment, step 303 generates and displays bar chart 200. In an embodiment, local explanation 150 contains or represents inference 140 and local value importances 151-152.

### 4.0 EXAMPLE ACCELERATED TRAINING PROCESS

FIG. 4 is a flow diagram that depicts an example process that computer 100 performs to train and validate attribution metamodel 160. This process includes: a) self supervision by slow generation of importance labels and b) acceleration by adaptive sampling and early stopping. As discussed earlier herein, the lifecycle of attribution metamodel 160 consists of a training phase followed by a production use phase. FIGS. 3-4 respectively represent the production and training phases (except below steps 405-406 that occur in production). Also as discussed earlier herein, the processes of FIGS. 3-4 do not access machine learning (ML) model 110.

The process of FIG. 4 begins between times T3-T4 of FIG. 1 and ends at time T10. That is, times T1-T2 already occurred before adaptive sampling for training attribution metamodel 160. As discussed earlier herein, training attribution metamodel 160 entails a sequence of training epochs. The shown upwards arrow from step 404 back to repeat step 401 indicates a transition from a previous epoch to a next epoch as discussed later herein.

Before the first training epoch, times T1-T2 already generated a voluminous and unlabeled archival corpus of history for attribution metamodel 160 consisting of too many unlabeled inferenced datapoints. Labeling all inferenced datapoints is temporally infeasible because state of the art importance measurement such as SHAP (Shapley Additive Explanations) values is combinatoric with respect to numerosity of features 121-122. Combinatoric complexity is factorial, which is slower than exponential that also is very slow. In other words, importance labeling is slow, and unconventionally less importance labeling is unconventional acceleration of training attribution metamodel 160. In various embodiments, the process of later FIG. 3 is unconventionally fast and performed in less than some or all of: one second, factorial time, and exponential time. Here, time complexity scales with a count of features 121-122.

Self-supervision labels that are importance labels (e.g. SHAP values) are incrementally (i.e. adaptively) generated in a sequence of, in this example, two training epochs that occur at respective times T5 and T8. Step 401 self-supervised trains attribution metamodel 160. Step 402 is a sub-step of training step 401. Herein, self supervision entails automatic importance labeling, which is automatic generation, in step 402, of importance labels for inferenced datapoints (i.e. not raw datapoints). For the inferenced datapoint (i.e. the raw datapoint and its inference 140), step 402 generates a special label. This special label does not indicate whether inference 140 is correct or incorrect. Instead, this special label contains state of the art importances to which inferred local value importances 151-152 can be compared in order to supervised measure training error or validation error. For example, step 402 may invoke SHAP to generate importance labels for inferenced datapoints.

Steps 401-402 train attribution metamodel 160 with a training corpus that is selected by adaptive sampling from historic inferenced datapoints 144 that is a huge unlabeled archival corpus that consists of too many inferenced datapoints available for labeling in feasible time and space. Herein, self-supervision labels are dynamically generated during adaptive sampling, and this labeling is accelerated by an unconventionally small sample size of a few unlabeled inferenced datapoints.

Step 403 self-supervised validates attribution metamodel 160 at time T7. Step 403 may, for example, process multiple validation datapoints, such as in a validation fold, and this entails multiple inferences by attribution metamodel 160 to generate multiple local value importances. Step 403 (e.g. cross) validates attribution metamodel 160 by measuring loss based on the self-supervision labels. Step 403 detects whether or not validation score 161 for attribution metamodel 160 exceeds validation threshold 162. If validation score 161 is insufficient, then step 404 at least doubles the sample size to exponentially grow the sample size. After step 404 transitions from the previous training epoch to the next epoch, step 401 is repeated in the next epoch.

If validation score 161 is sufficient, then attribution metamodel 160 passes validation, and the sequence of training epochs ceases. In an embodiment, the training corpus in the final training epoch does not contain more than twenty thousand datapoints, which is unconventionally small. After training, attribution metamodel 160 transitions from training mode to production mode and, possibly much later, step 405 occurs in production. Step 405 receives interactive request 170 at time T9 as discussed earlier herein and, responsively at time T10, step 406 generates local explanation 150 and optionally draws bar chart 200 as a presentation of local explanation 150 on a computer screen as discussed earlier herein.

### HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

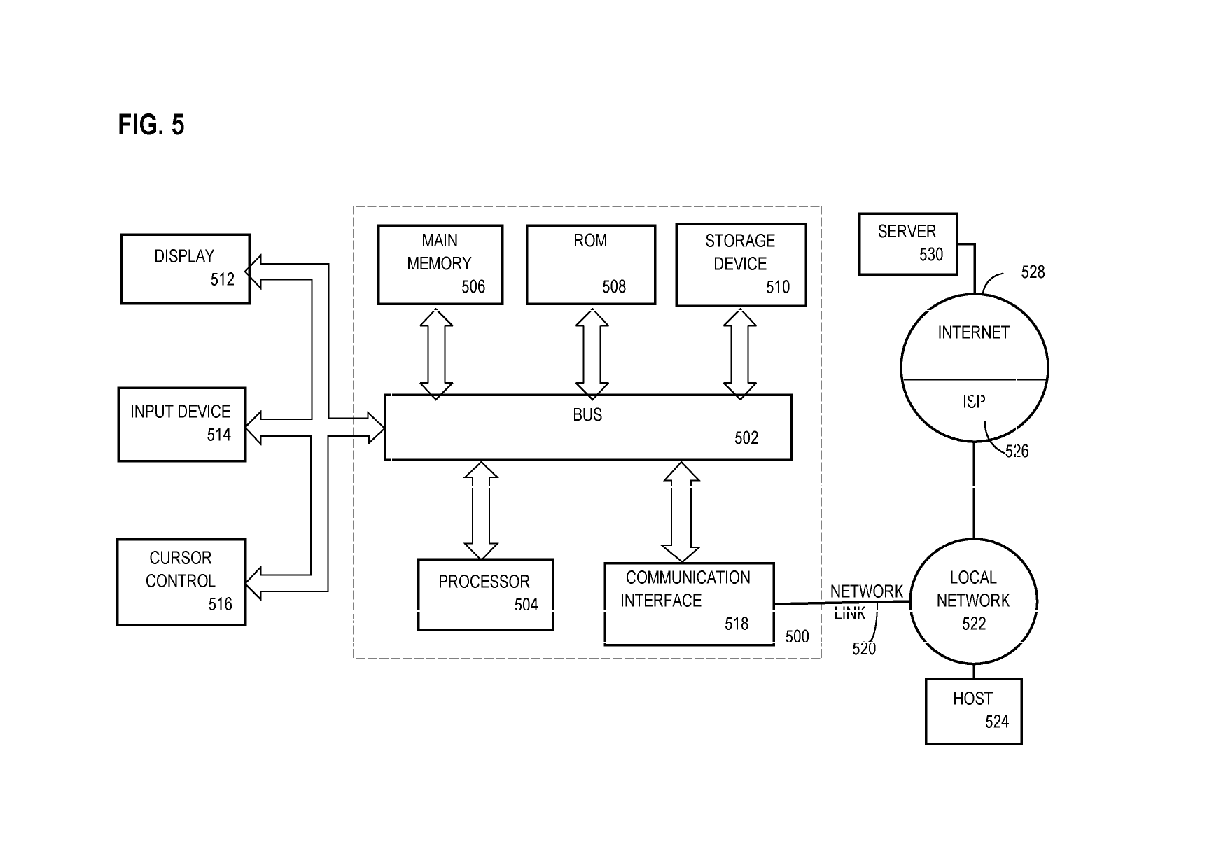

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term "storage media" as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the "Internet" 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### SOFTWARE OVERVIEW

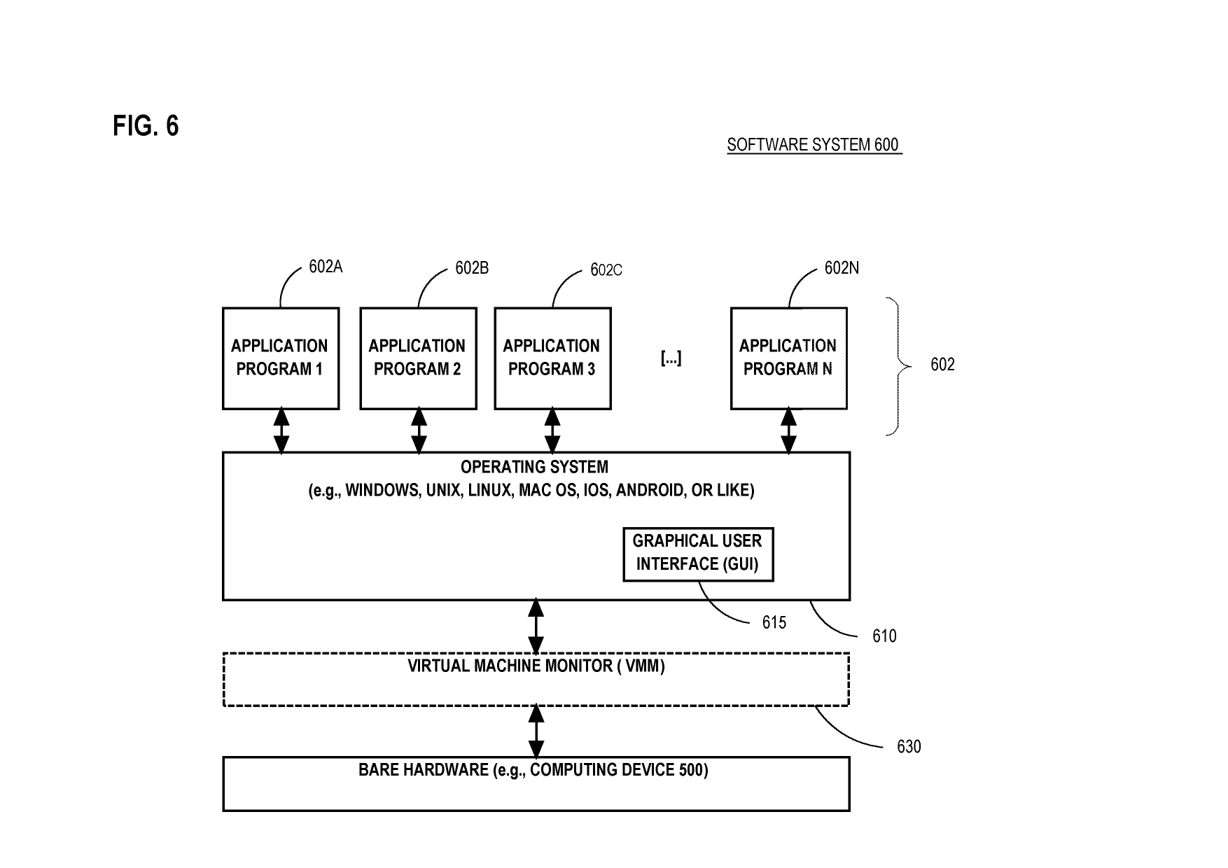

FIG. 6 is a block diagram of a basic software system 600 that may be employed for controlling the operation of computing system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computing system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (11O), and device I/O. One or more application programs, represented as 602A, 602B, 602C ... 602N, may be "loaded" (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., "point-and-click" or "touch gesture") fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software "cushion" or virtualization layer between the OS 610 and the bare hardware 620 of the computer system 500.

VMM 630 instantiates and runs one or more virtual machine instances ("guest machines"). Each guest machine comprises a "guest" operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is "aware" that it executes on a virtual machine monitor. In other words, VMM 630 may provide para- virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### CLOUD COMPUTING

The term "cloud computing" is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### MACHINE LEARNING MODELS

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a "known" output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### ARTIFICIAL NEURAL NETWORKS

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### ILLUSTRATIVE DATA STRUCTURES FOR NEURAL NETWORK

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L-1 to a layer L. Given the number of neurons in layer L-1 and L is N[L-1] and N[L], respectively, the dimensions of matrix W is N[L-1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L-1 to L. An activation neuron represents an activation function for the layer that includes the activation function. An activation neuron in layer L corresponds to a row of weights in a matrix W for the edges between layer L and L-1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### BACKPROPAGATION

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference "EXACT CALCULATION OF THE HESSIAN MATRIX FOR THE MULTI-LAYER PERCEPTRON," by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### AUTOENCODER

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) "VARIATIONAL AUTOENCODER BASED ANOMALY DETECTION USING RECONSTRUCTION PROBABILITY", Special Lecture on IE. 2015 Dec 25;2(1):1-18 by Jinwon An et al.

### PRINCIPAL COMPONENT ANALYSIS

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### RANDOM FOREST

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each- decision-tree, minimum-number-of-data-points-on-a-leaf-node, method-for-sampling-data- points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing, in a feature vector, a plurality of feature values for a plurality of features and, from the plurality of feature values, an inference by a machine learning model;
inferentially generating from the feature vector by multioutput regression by an attribution metamodel, a plurality of local value importances for the plurality of feature values for the inference; and
generating, based on the plurality of local value importances, and displaying a local explanation of the inference.

2. The method of claim 1 further comprising:
generating importance labels for a first plurality of inferences by the machine learning model;
detecting that a validation score for the attribution metamodel does not exceed a threshold;
generating, in response to said detecting, importance labels for a second plurality of inferences by the machine learning model that is at least twice the size of the first plurality of inferences.

3. The method of claim 2 performed without accessing the machine learning model.

4. The method of claim 2 wherein said importance labels for the first plurality of inferences comprise for a particular inference, an importance label that consists of a plurality of fractions.

5. The method of claim 2 wherein the validation score is a normalized discounted cumulative gain (NDCG) score that is based on said local value importances for the first plurality of inferences.

6. The method of claim 1 wherein said displaying comprising drawing a bar chart that contains:
on a first side of an origin for the bar chart, a first bar having a length that represents a value importance of a first feature and on a second side of the origin, a second bar having a length that represents a value importance of a second feature.

7. The method of claim 6 wherein:
the value importance of a second feature is negative;
combined lengths of a plurality of bars on the first side of the origin exceed combined lengths of a plurality of bars on the second side of the origin.

8. The method of claim 1 further comprising:
training the attribution metamodel with a training corpus that contains at most twenty thousand inferences by the machine learning model;
without further training, the attribution metamodel passing validation.

9. The method of claim 1 wherein:
the machine learning model is a classifier;
the inference is a classification that comprises a probability of a class;
a first local value importance of the plurality of local value importances is an estimated increment to the probability of the class;
a second local value importance of the plurality of local value importances is an estimated decrement to the probability of the class.

10. The method of claim 1:
performed in response to an interactive request, performed in less than one second, performed in less than factorial time, or performed in less than exponential time.

11. One or more non-transitory computer-readable media storing instructions that, when executed by one or more processors, cause:
storing, in a feature vector, a plurality of feature values for a plurality of features and, from the plurality of feature values, an inference by a machine learning model;
inferentially generating from the feature vector by multioutput regression by an attribution metamodel, a plurality of local value importances for the plurality of feature values for the inference; and
generating, based on the plurality of local value importances, and displaying a local explanation of the inference.

12. The one or more non-transitory computer-readable media of claim 11 wherein the instructions further cause:
generating importance labels for a first plurality of inferences by the machine learning model;
detecting that a validation score for the attribution metamodel does not exceed a threshold;
generating, in response to said detecting, importance labels for a second plurality of inferences by the machine learning model that is at least twice the size of the first plurality of inferences.

13. The one or more non-transitory computer-readable media of claim 12 performed without accessing the machine learning model.

14. The one or more non-transitory computer-readable media of claim 12 wherein said importance labels for the first plurality of inferences comprise for a particular inference,an importance label that consists of a plurality of fractions.

15. The one or more non-transitory computer-readable media of claim 12 wherein the validation score is a normalized discounted cumulative gain (NDCG) score that is based on said local value importances for the first plurality of inferences.

16. The one or more non-transitory computer-readable media of claim 11 wherein said displaying comprising drawing a bar chart that contains:
on a first side of an origin for the bar chart, a first bar having a length that represents a value importance of a first feature and on a second side of the origin, a second bar having a length that represents a value importance of a second feature.

17. The one or more non-transitory computer-readable media of claim 16 wherein:
the value importance of a second feature is negative;
combined lengths of a plurality of bars on the first side of the origin exceed combined lengths of a plurality of bars on the second side of the origin.

18. The one or more non-transitory computer-readable media of claim 11 wherein the instructions further cause:
training the attribution metamodel with a training corpus that contains at most twenty thousand inferences by the machine learning model;
without further training, the attribution metamodel passing validation.

19. The one or more non-transitory computer-readable media of claim 11 wherein:
the machine learning model is a classifier;
the inference is a classification that comprises a probability of a class;
a first local value importance of the plurality of local value importances is an estimated increment to the probability of the class;
a second local value importance of the plurality of local value importances is an estimated decrement to the probability of the class.

20. The one or more non-transitory computer-readable media of claim 11 wherein said inferentially generating is:
performed in response to an interactive request, performed in less than one second, performed in less than factorial time, or performed in less than exponential time.
